(19) United States
(12) Patent Application Publication
(10) Pub. No.: US 2009/0307233 A1
(43) Pub. Date: Dec. 10, 2009

(54) Efficient Handling of PMU Data for Wide Area Power System Monitoring and Visualization

(76) Inventors: Guorui Zhang, San Jose, CA (US); Hongtao Chen, Cupertino, CA (US)

Correspondence Address: CURATOLO SIDOTI CO., LPA, 24500 CENTER RIDGE ROAD, SUITE 280, CLEVELAND, OH, 44145, US

(21) Appl. No.: 12/476,939

(22) Filed: Jun. 2, 2009

Related U.S. Application Data
(60) Provisional application No. 61/058,058, filed on Jun. 2, 2008.
(60) Provisional application No. 61/059,306, filed on Jun. 6, 2008.

(51) Int. Cl. G06F 17/30; G06T 11/20; G06F 15/16

(52) U.S. Cl. 707/10; 345/440; 707/103 R; 707/104.1; 707/E17.055; 707/E17.107; 709/217; 709/203

(57) ABSTRACT

A real-time, wide-area power system monitoring and visualization system is provided, including comprising an application database adapted to contain a synchronized data object queue and configuration data; a web service; an event-triggered data archive service; an event database; and a smart client visualization application adapted to commence web service with the application database and the event database. A method of real-time, wide-area power system monitoring and visualization is also provided including receiving synchronized, real-time data objects in a first-in, first-out synchronized data object queue contained in an application database: requesting retrieval of the latest system-oriented data from the application database by a smart client visualization application; packaging the most recent system-oriented data into a lightweight data-interchange format; transmitting the most recent system-oriented data package to the client visualization system via a web service; and operating the smart client visualization application.

### CROSS-REFERENCE TO RELATED APPLICATIONS

The present application claims the benefit of the filing date, under 35 U.S.C. §119(e), from U.S. Provisional Application Ser. No. 61/058,058, filed Jun. 2, 2008, and U.S. Provisional Application Ser. No. 61/059,306, filed Jun. 6, 2008, which applications are incorporated herein by reference.

### TECHNICAL FIELD

Provided is a real-time, wide-area monitoring and visualization system in the field of power systems. More particularly, provided is a real-time, wide-area Phasor Measurement Unit (PMU) data and event visualization system in the field of monitoring and situational awareness of large interconnected power systems.

### BACKGROUND

The operators and regional or sub-regional security coordinators of a large interconnected power system need to know what is happening at their neighboring systems in order to improve their situation awareness. When a large event occurs in an interconnected power system, such as a large generator outage, large substation outage or a large transmission line or HVDC link outage, it will be very beneficial for the operators or security coordinators to know the estimated location, the magnitude, and the type of the event in real-time, such that the operators and security coordinators of the power systems affected by the event will be able to work together to take appropriate and coordinated control actions to handle the event.

Power system operators, managers and engineers use visualization systems to perform real-time monitoring, state estimation, stability control and post-event analysis of interconnected power systems. Such visualization systems assist power systems users in understanding and analyzing frequency characteristics and disturbance events of local and neighboring power systems. Such disturbance events include generator outages, load outages, and transmission outages. These visualization systems display real-time measurements from synchronized phasor measurement units (PMU) and GPS-based Frequency Data Recorders (I-DR) that are, or are to be, installed throughout the North American power grid.

A large number of GPS-based Phasor Measurement Units (PMU) have been installed or are planned to be installed in the Eastern Interconnection (EI). Western System Coordination Council and ERCOT in Texas power systems. In the last few years, more than 50 low-cost and GPS-based Frequency Data Recorders (FDR) have been installed in various locations in the United States, Canada and Europe. The output measurements of a PMU include GPS synchronized frequency, voltage magnitude, and phase angle for each phasor. A large PNU can have GPS synchronized measurements of up to 10 phasors with 20 to 30 samples per second.

Applications to utilize the synchronized PMU frequency and voltage measurements for the real-time monitoring, state estimation, stability control and post event analysis of interconnected power systems have been investigated. One of these applications is being developed by Virginia Tech to perform on-line triggering and to identify the location of disturbances (LOD) of power systems using the synchronized frequency measurements of the PMUs and FDRs. The Tennessee Valley Authority (TVA) has developed a repository for synchronized PMU measurements for all the Phasor Measurement Units installed in the North America.

Existing power system visualization systems using PMU data are implemented on client-server technologies. Such existing systems may not have high-fidelity event replay features and their performance does not meet the requirements for wide area real time monitoring and event replay for a large number of PMUs and a large number of concurrent users.

Incorporated herein by reference are U.S. Pat. No. 7,216,007 directed to a system and method for providing direct web access to controllers in a process control environment, U.S. Pat. No. 7,233,843 directed to real-time performance monitoring and management system, and US Patent Publication 2006/0224336 A1 directed to a system and method for transmitting power system data over a wide area network.

The main performance challenges for wide area power system visualization applications are the efficient handling of a large volume of real time or historical PMU measurements and a large number of concurrent users for real-time monitoring and event replay. The large volume of real time PMU measurement data needs to be transferred from the PMU data center to the visualization application server, and then transferred from the application server to each user's computer for real time monitoring. For event replay, all the PMU measurements related to an event for a time window between 15 seconds to 300 seconds needs to be transferred from the visualization application database to the computer of the user who requests the replay of one of the existing events. These present huge performance challenges, particularly when a large number of users perform the replay of different events for post event analysis.

Thus, there is a need in the power systems management industry for a more automated, enhanced situational awareness, power system monitoring and visualization system of a large interconnected power systems for a larger number of application users, including operators, operations engineers, and regional and sub-regional security coordinators.

### BRIEF DESCRIPTION OF THE DRAWINGS

FIG. 1 is a schematic representation of a system design overview diagram of one embodiment of a wide-area real-time power system monitoring and visualization system.

FIG. 2 is a screen shot of a frequency visualization control computer display.

FIG. 2A is a computer screen shot of a frequency contour display showing angle differences using simulated PMU frequency data.

FIG. 3 is a computer display screen shot of a real-time frequency monitoring using simulation data.

FIG. 3A is computer display screen shot of a voltage phase angle contour showing angle differences using simulated PMU data.

FIG. 4 is a computer display screen shot of a frequency contour for event replay.

FIG. 4A is a computer screen shot of a frequency contour display of a large generator outage event with the event location shown in a triangular symbol.

FIG. 4B is a computer screen shot of a frequency visualization display with generator outage data (zoomed in).

FIG. 5 is a screen shot of a polygon frequency computer display for event replay.

FIG. 5B is a computer screen shot of the polygon frequency display (zoomed in).

FIG. 6 is a computer screen shot of a voltage magnitude visualization display using simulated PMU data.

FIG. 7 is a computer display screen shot of a frequency trend chart for selected measurements.

FIG. 7A is a computer display screen shot of a frequency trend chart related to a generator outage event.

FIG. 8 is a computer display screen shot of a frequency trend chart (zoomed in).

FIG. 8A is a computer display screen shot of the frequency trending chart related to a generator outage event (zoomed in).

FIG. 9 is a schematic representation of the system architecture of one embodiment of a large-volume PMU data handling power system monitoring and visualization system.

FIG. 10 is a computer display screen shot of a wide-area power system event replay showing frequency contour data (optionally at a refresh rate of 10 to 30 times per second.)

### DETAILED DESCRIPTION

In one embodiment, a real-time, wide area power monitoring and visualization system and high fidelity post event replay system using smart client application software is provided. This system significantly improves the performance of wide area power system visualization to handle a large volume of real-time frequency measurements and a large number of users for real-time power system frequency monitoring, wide area power system visualization and high fidelity event replay. This system comprises an application database which receives and then queues phasor measurement unit (PMU) data and optionally frequency data recorder (FDR) data; an event database which stores event data; a web service which may utilize a lightweight data-interchange format to package PMU. FDR, and event data; and a visualization client which utilizes smart client application software to interact with the web service to obtain PMU, FDR, and event data, and which locally processes the aforementioned data for real-time frequency monitoring and event replay.

Embodiments of the visualization system are described in greater detail with reference to FIGS. 1 through 10. It should be noted that the figures merely show illustrative embodiments of the visualization system, and the scope of the visualization system is not intended to be limited by the illustrative embodiments shown in the figures.

The term “data” refers to phasor measurement unit (PMU) data and optionally frequency data recorder (FDR) data.

The term “smart client visualization application” refers to a client software application that dynamically requests and receives synchronized, real-time data objects over an http (web services) connection using a smart client application such as Windows Smart Client software, and can update and display the system-oriented data for real time monitoring and/or event-oriented data for historical, post event analysis.

The term “synchronized real-time data object” refers to system-oriented data and/or event-oriented data.

The term “system-oriented data” refers to, and includes but is not limited to, the following: frequency, voltage magnitudes, voltage phasor angles measurement equipment data including name, type, location, owner and the related information; real-time GPS synchronized PMU data including the frequency, time, voltage measurements, and equipment unit identifier; color code data for each frequency interval; regional and coastline data; and configuration parameters.

The term “event-oriented data” refers to, and includes but is not limited to, the following data: event identifier, event time, event magnitude in megawatts (MW), event message, and event-related PMU data.

A real-time, wide-area frequency monitoring and visualization application may utilize a smart client application in order to improve the performance and user experience by fully utilizing the local computer resources and the benefits of Internet, based on Web Service applications. The real-time frequency visualization application may be integrated with the Synchronous Frequency Measurement System (SFMS) or the Synchronized Phasor Measurement System (SPMS) developed by TVA.

Smart clients are easily deployed and managed client applications that provide an adaptive, responsive and rich interactive experience by leveraging local computing resources and connecting intelligently to distributed data sources. Unlike browser based applications, smart client applications install on the user's PC, laptop, or other smart devices. Smart client applications, when connected to the Internet or intranet, can exchange data with systems across the Internet or the enterprise. Web services, which are widely used in smart client applications, allow the smart client application to utilize industry standard protocols such as XML. HTTP and SOAP to any type of remote system. Smart client applications have the ability to work whether connected to the Internet or not. Smart client applications can be easily deployed from a centralized Web server, and can also be automatically updated to the latest version of the software installed on the centralized server.

A system design overview diagram of one embodiment of a wide-area real-time power system monitoring and visualization system is shown in FIG. 1. Although a frequency visualization system is discussed for purposes of illustration, it is to be understood that the present system and method provides real-time, wide area visualization of not only frequency data, but also additional PMU data such as voltage magnitude and angle, current magnitude and angle, and the like. In one embodiment, a frequency visualization system may include the following modules:

A. Synchronized Phasor Measurement System (SPMS)

The SPMS data server 11 retrieves, processes and stores the synchronized phasor measurements including frequencies, voltages, voltage angles and current data. The SPMS database, developed by TVA, stores user information including the user ID and password, and the real-time and historical synchronized frequency data, which are transferred from the Eastern Interconnection Phasor Project (EIPP), PMU data server (not shown in FIG. 1) and the FDR data server (not shown in FIG. 1). The frequency database also stores the frequency measurement data and the identified event data obtained from PMU and/or FDR devices 31. The real-time synchronized phasor measurement data including frequency data is transferred from the data server 11 to the application server 41 periodically (every one or two seconds) and the event data is transferred immediately after an event is identified. The data server 11 may also perform the user authentication, such that only the registered users will be able to log in and use the real-time frequency visualization application. An on-line event trigger application 13 and a location of disturbance (LOD) application 14, such as those developed by Virginia Tech, can monitor and analyze all the real-time frequency data. The LOD application 14 detects any major system disturbance, including but not limited to, a large generator tripping, an HVDC link outage, and large load outages. The estimated system disturbance (event) information (such as location, magnitude (MW), time and the related event message) will immediately be transferred via web service and stored in the event oriented application database 42.

B. Frequency Application Server

The frequency application server 41 may include an event oriented relational application database 42, and may use Microsoft SQL 2005 Server and an application service 43. The application service 43 may be associated with a memory resident database 44 to efficiently handle the large volume of real-time and event related synchronized phasor measurement data. In certain embodiments, the real-time synchronized frequencies are periodically (such as every 1 or 2 seconds) sent from the data server 11 to the application server 41 using remote procedure call (RPC).

C. Web Server

The web server 21 performs the following functions:
1. Obtains the real-time event data and the measurement equipment data from the data server 11, optionally via a data transfer layer 22.
2. Sends the real-time frequency data, and the event information when an event occurs, optionally via a visualization web service 23, to each smart client. i.e. visualization application on each user computer 24, for performing real-time security monitoring using a visualization application.
3. Sends the event information and the event related measurement data, optionally via the visualization web service 23, to each smart client. i.e. visualization application on each user computer 24, for event replay application.

In one embodiment, the real-time system frequency visualization application for the user computers 24 may use Smart Client, Microsoft .NET 2.0 and object-oriented programming language Visual C#. The frequency visualization application may provide the following functions:
1. Wide area real-time frequency monitoring. When a large system event (e.g. generator outage, load outage or major HVDC link outage) occurs, the identified event (time, location and magnitude) may be shown on a display.
2 Real-time event replay for the latest event. This function allows the user to replay the system frequency visualization for the latest (most recent) time period.
3. Event replay for post event analysis.
4. Trending charting of the selected synchronized measurements.
5. Event replay when the user's PC or laptop is disconnected from the Internet or intranet.

All the frequency visualization displays can be shown in the normal mode or in frequency contour mode. The main components of the frequency visualization application and the features developed for improving the system performance include the following:

A. Application Database

The event oriented application database 42 may be a relational database, and may use Microsoft SQL Server 2005 or Oracle database. This application database 42 may contain the following tables:
1 PMU (and optionally FDR) equipment data including name, type, location, owner and other related information.
2. Event data including event identifier, time, magnitude in MW and event message.
3. Event related synchronized measurement data.
4. Color code data for each frequency interval, used for the frequency visualization display.
5. Regional and Coastline data
6. Configuration parameters

In one embodiment of the event oriented application database 42, the event related frequency data is stored in an event frequency table. For one embodiment of the application database 42, the frequency data occurring in twelve (12) seconds (two (2) seconds before the event time and ten (10) seconds after the event time) is stored in the event frequency table. This arrangement greatly reduces the number of frequencies to be transferred from the application database 42 to each client 24.

For the Eastern Interconnected power system, the system frequency varies in a small range even for large generator outages (e.g. 1200 MW). The frequency color code used for the frequency visualization may be agreed by utilities using this application with more color refinement in the typical frequency ranges such from 59.95 to 60.05 Hz. In an exemplified embodiment of this frequency visualization application, the frequency colors will change from dark blue to dark red when the frequency changes from 59.5 Hz to 60.2 Hz. This frequency color code can be easily updated if necessary.

B. Application Service

The application service 43 is used to:
1. Get real-time frequency data.
2. Get new event data when an event is identified.
3. Perform user authentication and access control.
4. Update synchronized frequency measurement equipment data.

C. Performance Improvement
A Frequency Data Collection Service installed at the application server 41 calls and obtains the real-time frequency data periodically and stores the real-time frequency data in the memory resident database 44.

In one embodiment, it is assumed that the real-time frequency data is transferred from the data server 11 to the frequency application server 41 every 1 second with reduced resolution (each PMU measurement may have 20 to 30 samples per second).

For the implementation of option 1, it is a time-consuming task to insert the real-time frequency data into the relational application database for a large number (e.g. 500) PMU/FDR units. It is also necessary to delete the old frequency data when the application database becomes too large. It is also necessary to read the real-time frequency data from the application database 42 for each user 24 for real-time frequency monitoring. The implementation of this option requires a large number of database writing and reading operations, significantly reducing the performance of the application server 41.

The implementation of option 2 greatly improves performance by storing a specified range (i.e. 120 seconds) of the latest real-time frequency data in the memory resident database 44 associated with the application service 43 thus eliminating the unnecessary and time-consuming database operations (inserting and reading) for the real-time frequency data. The real-time data may be transferred every 1 second directly from the memory resident database 44 of the application service 43 to the smart client on each user's PC or laptop 24 for real-time frequency monitoring. When the application server 41 receives an event, the frequency data (2 seconds before the event time and 10 seconds after the event time) and the event data are inserted into the application database 42 for event replaying. The implementation of option 2 eliminates the requirement for regularly deleting the real-time frequency data. Option 2 is several times faster as compared to option 1 for handling real-time frequency data for test cases.

D. Fast Frequency Contour Algorithms

The voltage contour algorithm according to one embodiment is set forth below for voltage contours for power system visualization. Similarly, a power system can also be visualized as a two-dimensional frequency visualization display. A frequency display can be divided into M by N grids. A grid with a frequency measurement is called a measurement grid and is assigned with the measured frequency. A grid without a frequency measurement is called virtual grid and its virtual frequency needs to be calculated. In the calculation of the virtual frequency of a virtual grid, the frequency measurement units which are closer to the virtual grid may be weighted more than those which are farther away. A fast frequency contour algorithm may be implemented, particularly for real-time frequency replay and for event frequency replay functions, since the frequency of each grid of the display may need to be calculated for each time frame (10 frames per second).

$$Fp = ( \frac{{\sum }_{i ∈ A} ( 1 / ( Dpi ⋆ Dpi ) Fi )}{{\sum }_{k ∈ A} ( 1 / ( Dpk ⋆ Dpk ) )} ) \qquad ( 1 )$$

### Where

Fp=Frequency for grid p
Fi=Frequency for grid i
Dpi=Distance from grid p to grid i
A=Subset of grids within a specified distance from grid p and in the same power system region.

The weighting factor Wpi for Fi for grid p depends on grid locations and can be pre-calculated at initialization as follows:

$$Wpi = \frac{( 1 / ( Dpi ⋆ Dpi ) )}{( {\sum }_{k ∈ A} ( 1 / ( Dpk ⋆ Dpk ) ) )} \qquad ( 2 )$$

Therefore, the frequency at grid p for each time frame can quickly be calculated as follows:

$$Fp = {\sum }_{i ∈ A} ( Wpi ⋆ Fi ) ) \qquad ( 3 )$$

The North American power system consists of three regions (WECC, Eastern Interconnection and ERCOT) which are connected using HVDC links. One feature is that the frequency contour algorithm will respect the regional boundaries and coastline boundaries.

E. Polygon Frequency Display Algorithm

A polygon type of frequency display algorithm may also be used for frequency visualization. In this algorithm, a grid on the display without a frequency measurement will be assigned the frequency of the closest frequency measurement. The polygon for each frequency measurement depends only on the grid locations and is calculated at initialization. Each polygon is assigned the same frequency of the measurement unit in the polygon for each time frame for the frequency visualization application. Each polygon is painted as one object for the visualization display to speed up the display drawing. It should be noted that the polygon method does not require the weighting factors of Eq. (2) to be calculated and stored for each cell of the grid as used for the frequency contour display. Instead, a polygon is automatically constructed at the initialization for each valid frequency measurement unit. Each polygon is drawn as an object using the frequency of the corresponding frequency measurement unit for each time frame for polygon display. When the number of measurement units is increased, this method automatically shows higher resolution and the computation burden does not significantly increase for the polygon frequency display.

F. Event Replay Frequency Visualization

The event replay function is provided for frequency visualization for the selected event. This function is very useful for post event analysis. The user can also select one of more than one frequency measurement units to display frequency trending charts.

Test Results

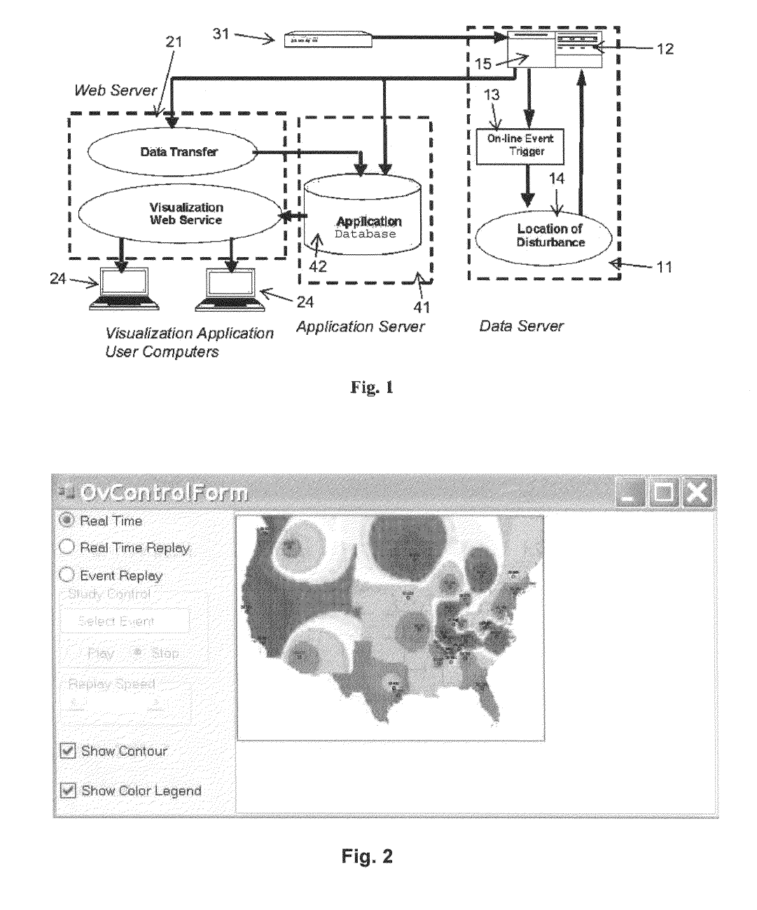

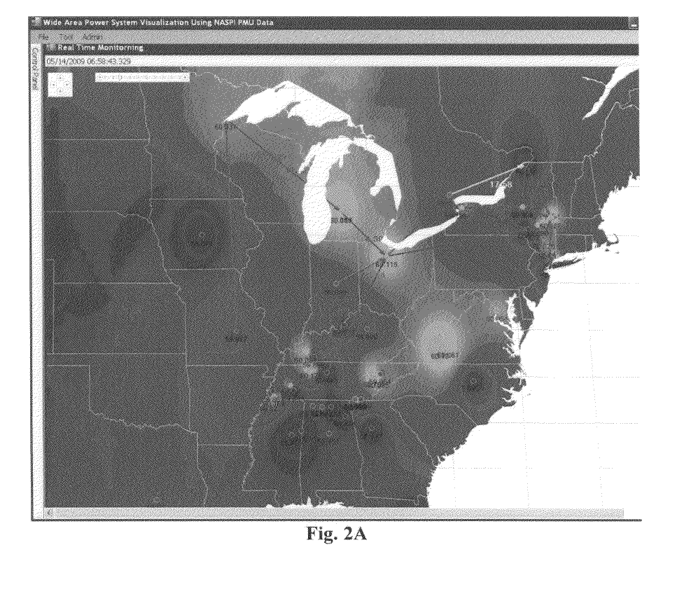

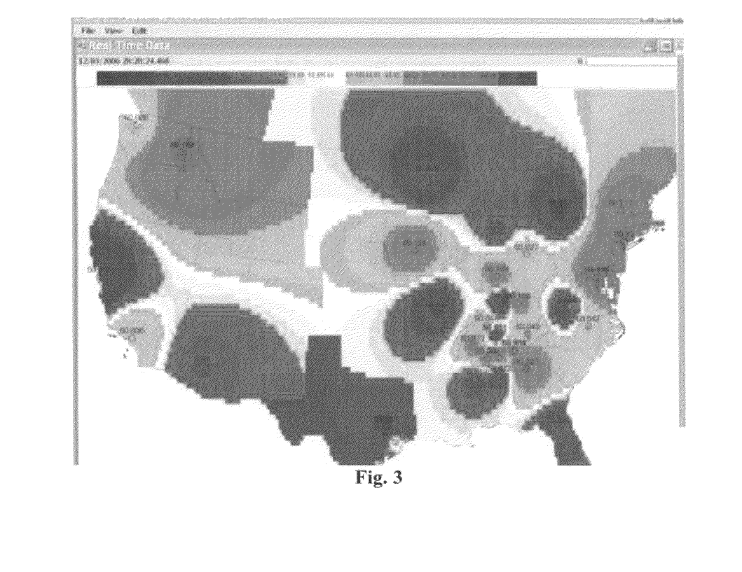

The wide area frequency visualization application has been tested using simulation frequency data and actual frequency data related to two events of generator outages which occurred in 2006. For the testing of real-time frequency monitoring and visualization, simulation frequency data was used. The simulation frequency data was randomly generated within the range of 59.5 to 60.5 Hz for each synchronized frequency measurement units. The actual event frequency data, which was obtained from the synchronized Frequency Data Recorders (FDR) of the Frequency Network (FNET) server at Virginia Tech, was used for the testing of the event replaying of the frequency visualization application. Thirty-four (34) synchronized FDR units were used for the testing. Five of them were installed in the WECC region, twenty seven of them were installed in the Eastern Interconnection region and two installed in the ERCOT (Texas) region. There were 10 frequencies per second for each synchronized frequency measurement unit. (The test results are described in the following sections.) A frequency visualization control display is shown in FIG. 2. A computer screen shot of a frequency contour display showing angle differences using simulated PMU frequency data is shown in FIG. 2A.

The main features of the visualization application can be generally divided into the following modes:

1. Real-time Monitoring

2. Real-time Replay

3. Event Replay

The frequency contour can be selected to show the frequency contour for the real-time frequency monitoring, real-time frequency replay, or event replay modes. The user can select one of the existing events stored in the application database for event replaying. The color legend can also be selected to show the frequency color legend on the frequency visualization display. In the real-time replay and event replay modes, the user can speed up or slow down the replay speed. The user can also use a zooming feature to examine the frequencies in more detail in the specified area on the visualization display.

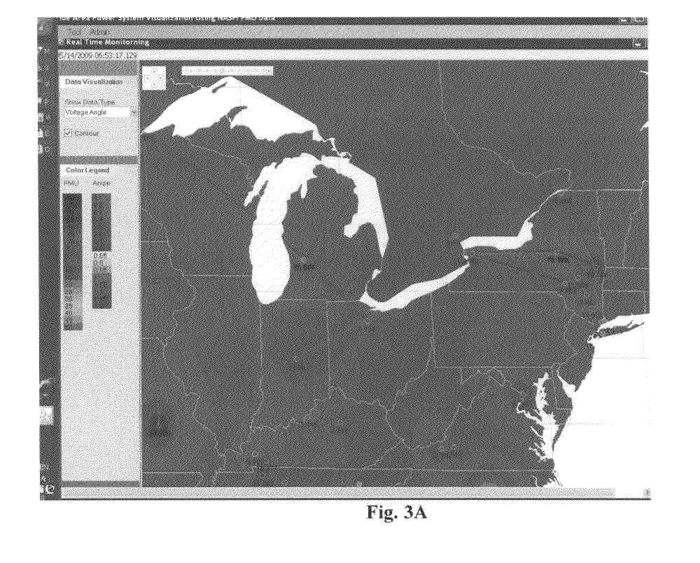

A real-time frequency monitoring display is shown in FIG. 3. When a large system event is detected and identified by the location of disturbance (LOD) function, the event location, the magnitude in MW and the related event message will be shown on the real-time frequency display. The real-time wide area monitoring and visualization system can process and display voltage, phase angle and angle difference data in addition to frequency data, as discussed above. A real-time monitoring display showing a voltage phase angle contour indicating angle differences using simulated PMU data is shown in FIG. 3A.

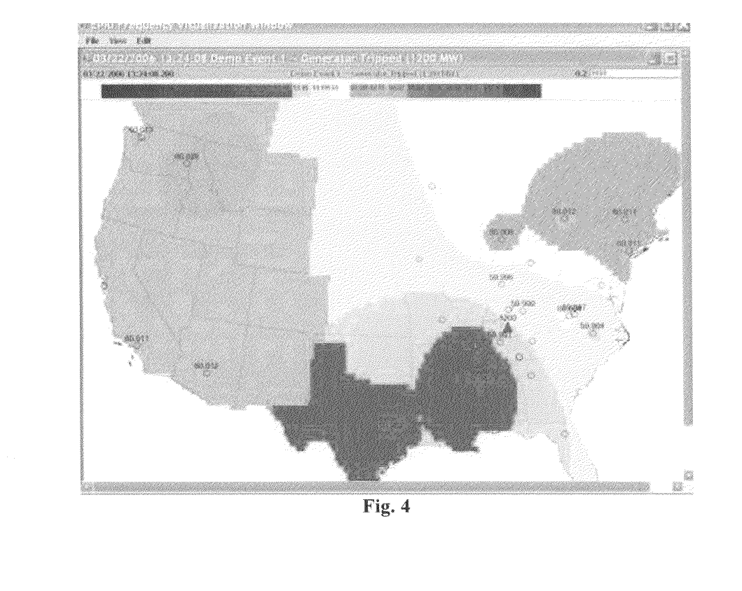

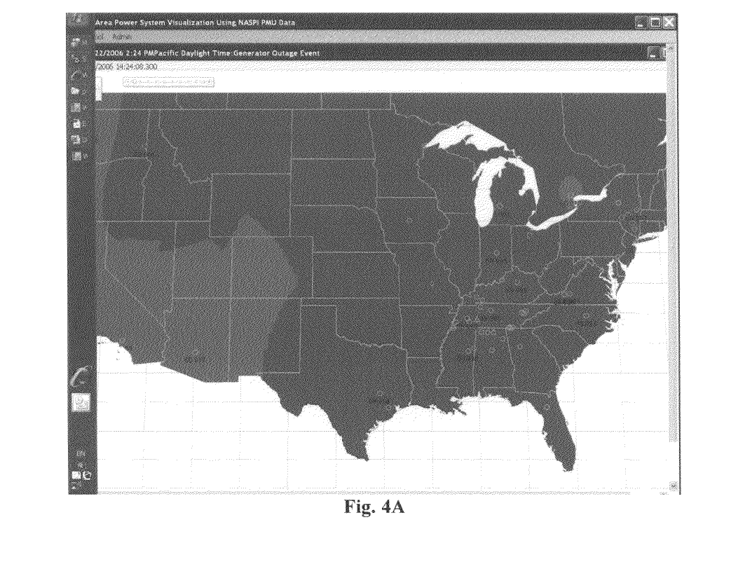

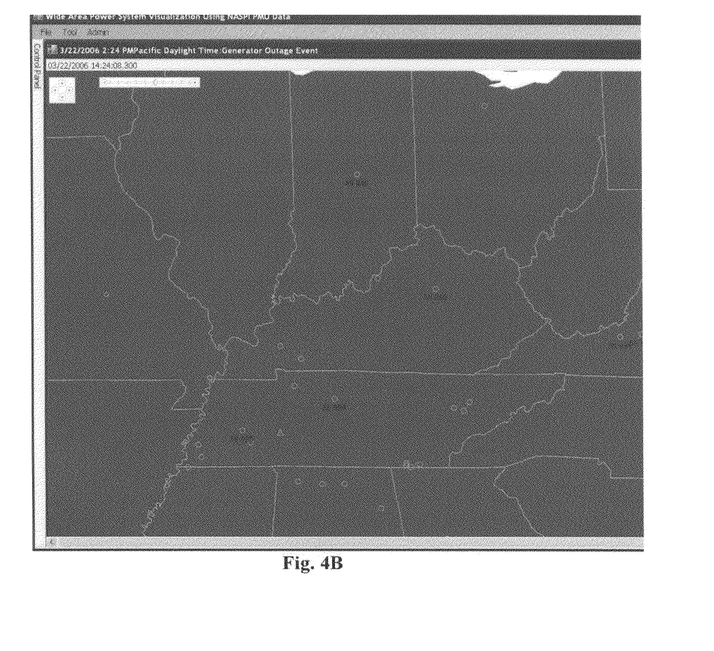

The frequency contour for a generator outage event is shown in FIG. 4, and another is shown in FIG. 4A. The event location (triangular shape), the event magnitude in MW and the event message are displayed immediately at the time (time 0) when the event occurred. Due to the sensitivity of the outage location of the event, the event location shown on the display was not the actual event location. The frequency contour display respects the regional boundaries of the North American interconnected power system. The contour frequency visualization display of the generator outage event of FIG. 4A is shown enlarged in FIG. 4B, by zooming in for the selected area.

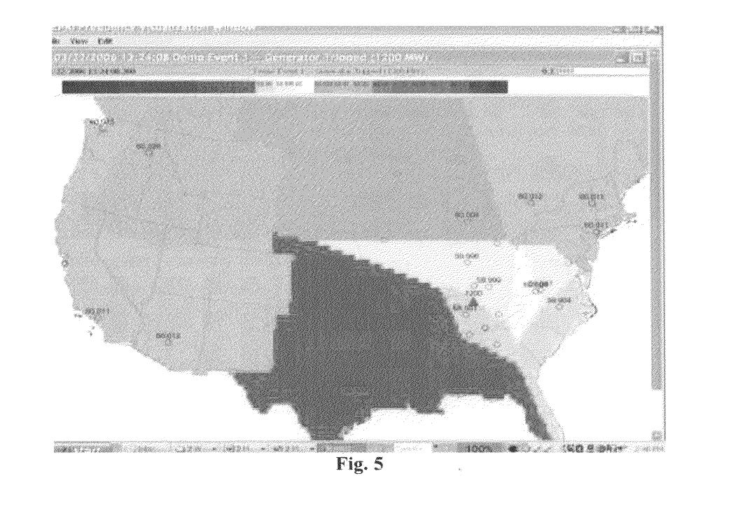

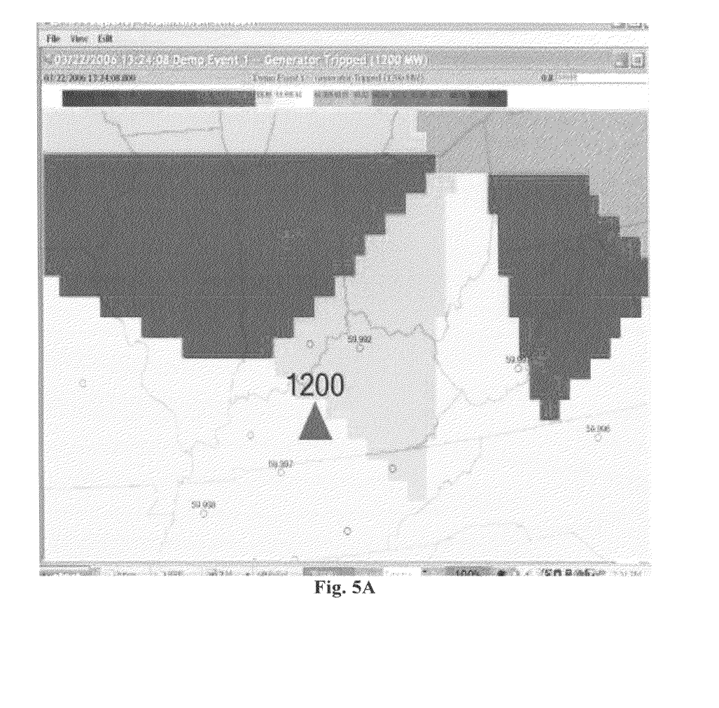

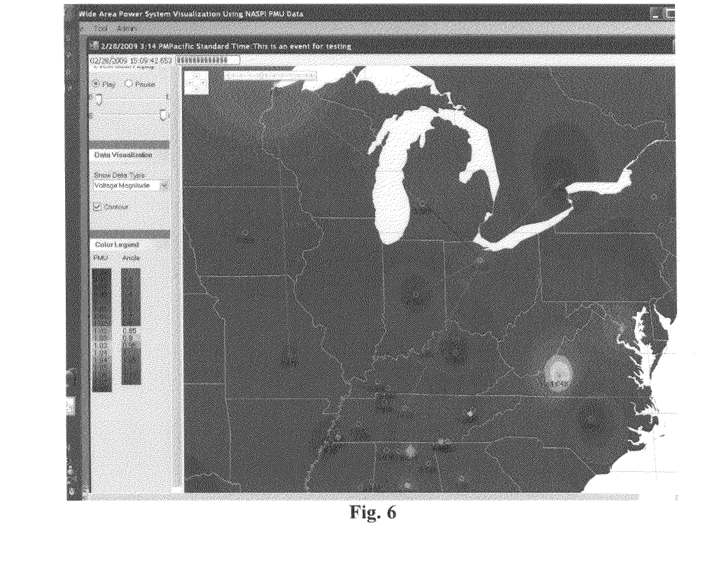

A polygon frequency display for an event is shown in FIG. 5. The frequency visualization can be zoomed in to display the frequency contour for the selected area as shown in FIG. 5A. Voltage data such as, phase angle and angle difference can be monitored and displayed, as discussed above. A voltage magnitude visualization display using simulated PMU data for an event is shown in FIG. 6.

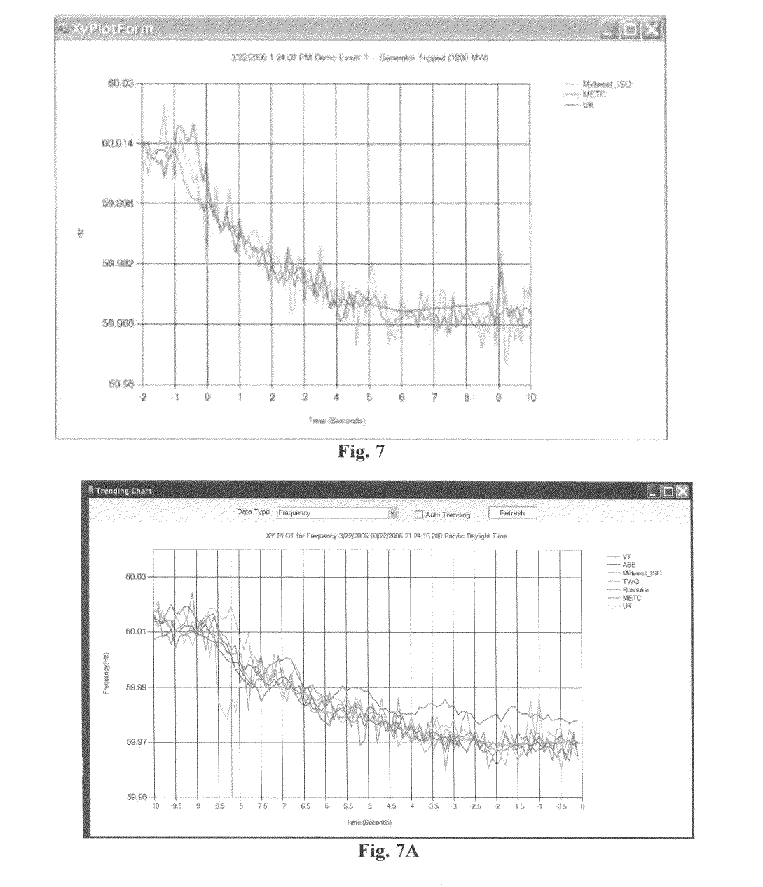

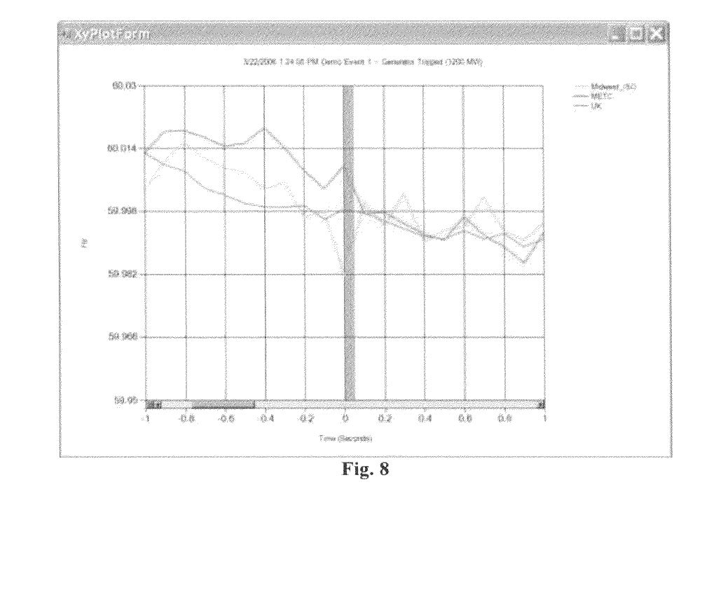

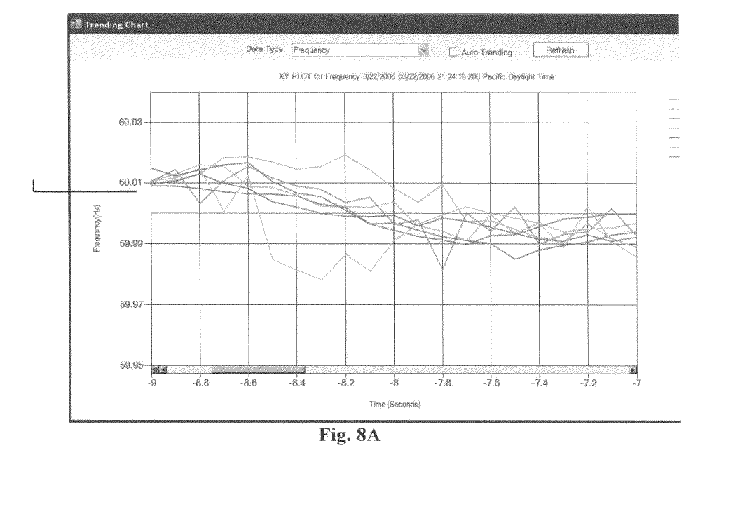

The frequency visualization application allows the user to select one frequency measurement unit or a set of frequency measurement units on the frequency visualization display to show the frequency trending chart as shown in FIGS. 7 and 7A. The user can also use the zooming feature to select the time interval to show a frequency trending chart in detail as shown in FIGS. 8 and 8A.

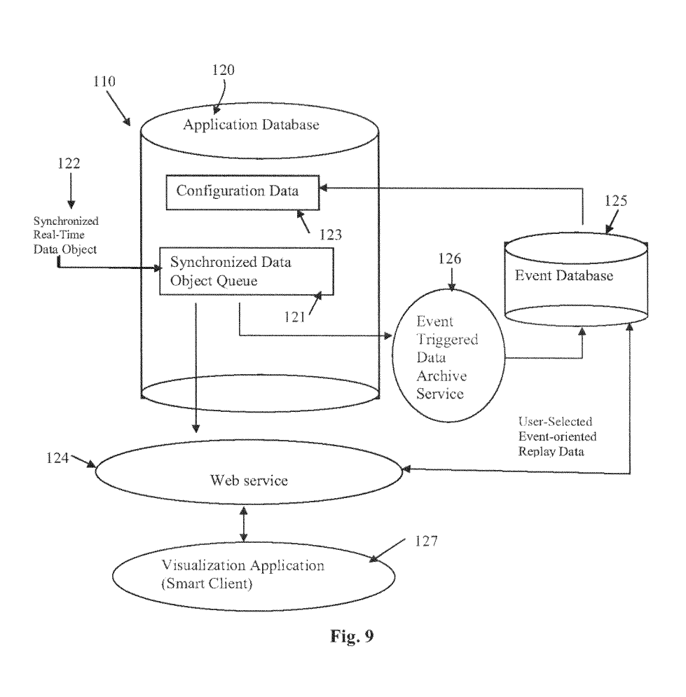

One embodiment of the present monitoring and visualization system for efficient handling of PMU data is shown in FIG. 9. According to this embodiment, visualization system 110 includes application database 120. Application database 120 comprises a synchronized data object queue 121 and configuration data 123. The synchronized data object queue 121 receives a synchronized, real-time data object 122. The synchronized data object queue 121 maintains a sufficient size in order to capture enough event-oriented data upon detection of a disturbance event (such as data from 2 seconds before, and 10 seconds after the event). For example, the synchronized data object queue 121 can be a first-in, first-out queue that removes the oldest synchronized, real-time data objects 122 that entered the synchronized data object queue 121.

The synchronized data object queue 121 then transfers system-oriented data to the web service 124. When a power system event occurs, such as a large generator outage, the synchronized data object queue transfers the event-oriented data to a event database 125, using an event-triggered data archive service 126. Such an event database may be contained in permanent, non-volatile storage. Event-oriented data generates the most data amongst the synchronized, real-time data objects 122; therefore placing the event-oriented data in an event database 125 alleviates storage demands on the computer of the smart client visualization application 127.

The smart client visualization application 127 may commence web service 124 with application database 120. Smart client visualization application 127 then requests to application database 120 retrieval of the latest system-oriented data. Certain embodiments perform such requests at rates of ten to thirty times per second. The latest (most recent) system-oriented data in the application database 120 is packaged into a lightweight data-interchange format and transmitted to client visualization system visualization system 127 as a light-weight data stream via web service 124. Lightweight data-interchange formats may comprise universal data structures, such as JavaScript Object Notation (JSON) or others.

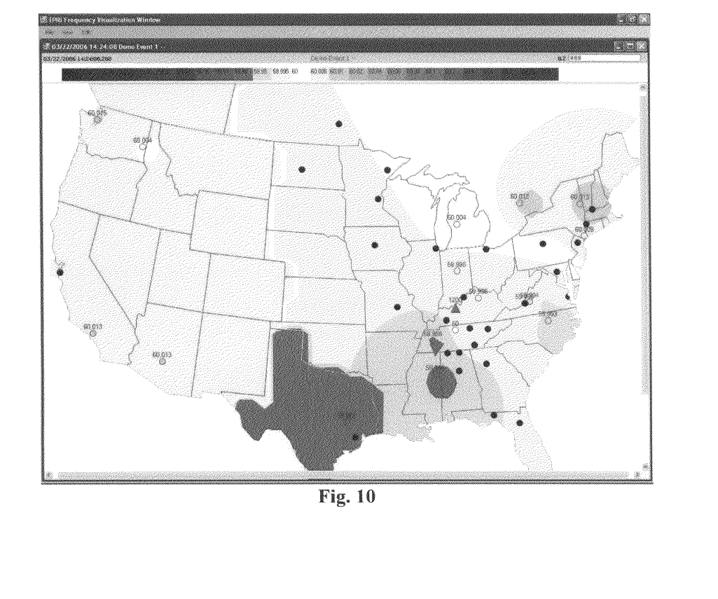

Still referring to FIG. 9, a user of smart client visualization application 127 that wishes to perform a post event analysis selects a particular event from an event list and selects a specified time window within smart client visualization application 127. The smart client visualization application 127 commences web service 124 with event database 125. Smart client visualization application 127 then requests to event database 125 retrieval of the latest event-oriented data. The latest (most recent) or alternatively, historical event-oriented data from the event database 125 is packaged into a lightweight data-interchange format and transmitted to client visualization system visualization system 127 via web service 124. The event replay may then be performed exclusively at the smart client visualization application 127, utilizing local resources and the event-oriented data stored in the local computer. FIG. 10 shows such an event replay. Therefore, the smart client visualization application 127 can perform the event replay offline and disconnected from web service 124. However, while online, the smart client visualization application can display voltage or frequency contour calculations data with an update, or refresh rate, of up to 10 to 30 times per second.

A real-time, wide-area monitoring and visualization application for GPS synchronized measurements including Phasor Measurement Units (PMU) and Frequency Data Recorders (FDR) using advanced Windows Smart Client software or an equivalent smart client application is provided. This real-time, wide area visualization application can show the location, magnitude and the related event message on the display in real-time by integration with the on-line event triggering and location of disturbance applications. This application fully utilizes the local computer resources and the Internet technology, providing hi-fidelity visualization in real-time for large interconnected power systems. The smart client software used for the real time, wide area monitoring and visualization application significantly improves the performance by fully utilizing the local computer resources, the Internet and web services. The performance of this application has also been significantly improved by using the queue object to efficiently handle a large volume of real-time and historical PMU data, event related PMU data and a large number of concurrent users of the power system visualization application. The system event replaying function plus a multiple trending charting function are very useful for power system operators and engineers to perform post event analysis.

The application using smart client software can be used whether it is online or offline. This application can be used for significantly improving the situation awareness of the operators in energy management systems and the regional and sub-regional security coordinators of large interconnected systems. The wide area contours for the real-time monitoring and event replay functions provide an Interconnection overview. The location, magnitude and the related event message shown on the display immediately after the event occurs allows the users to know what is happening in the interconnected power system and to take appropriate control actions if necessary. The deployment and updating of this application is greatly simplified by utilizing the benefits of the Microsoft .NET Framework, the XCOPY deployment and side by side versioning.

Wide area power system visualization using the real-time measurements from synchronized phasor measurement units (PMU) and FDR assists in improving operator situation awareness and power system monitoring. It is helpful for the power system operators, managers and engineers to quickly understand and analyze the current and previous large generator and transmission outage events via event replay. The present system and method significantly improve the performance of the wide area power system monitoring and visualization system to handle a large volume of real-time PMU/FDR measurements (10 to 30 samples per second) and a large number of users for real-time monitoring and event replay.

The present system and method enable the efficient handling of a large volume of real-time and historical system-oriented data and event-oriented data in order to meet the performance requirements for real-time wide area monitoring and event replay by a large number of users.

The present system and method provide at least one of:

1. Large-volume data-interchange using a memory resident database with a synchronized data object queue. Real-Time PMU and/or FDR data are measurements with a typical scan rate of 10-30 samples per second. The data will be pushed into a queue for easy access of the most recent data for monitoring purpose while the queue is to maintain sufficient size in order to capture the event data in case a disturbance event is detected.
2. High performance event replay by fully utilizing local computer resources, using smart client software.
3. Innovative handling of real-time monitoring and event replay.
4. Application oriented data transfer using web service and a lightweight data interchange format such as JSON or the like to transfer only the related data required for the related visualization.
5. Efficient handling of the event related data using an event oriented database. When a power system event (e.g. a large generator outage) occurs, the event related PMU/FDR data and the related event data will be stored in the event orient database. When a user of the wide area visualization application selects an event from the event list for the specified time window, the selected event PMU/FDR data will be transferred from the event oriented application database server to the user's computer via web services for post event analysis. The event replay may be performed locally using the PMU data stored in the local computer. It is only necessary to transfer the event related PMU data from the application database when the event selected by the user for reply has not been transferred to the user's computer. This approach allows high performance and computation-intensive event replay for post event analysis by large number of users. The utilization of smart client software also allows the user to perform the event replay off-line (disconnected from the application web server).

The real-time, wide area power system monitoring and visualization system is not limited to the specific embodiments described above, but includes variations, modifications, and equivalent embodiments defined by the following claims. The embodiment described above is not necessarily in the alternative, as various embodiments may be combined to provide the desired characteristics.

We claim:

1. A real-time, wide-area power system monitoring and visualization system comprising an application memory resident database adapted to contain a synchronized data object queue and configuration data; a web service; an event-triggered data archive service; an event database; and a smart client visualization application adapted to commence web service with the application database and the event database.

2. The system of claim 1 wherein the synchronized data object queue is adapted to receive synchronized, real-time data objects.

3. The system of claim 1 wherein the synchronized data object queue comprises a first-in, first-out queue that removes the oldest synchronized, real-time data objects that entered the synchronized data object queue.

4. The system of claim 1 wherein the synchronized data object queue is adapted to transfer system-oriented data to the web service.

5. The system of claim 1 wherein the synchronized data object queue is adapted to transfer event-oriented data to the event database, using the event-triggered data archive service.

6. The system of claim 1 wherein the event database is contained in permanent, non-volatile storage.

7. The system of claim 1 wherein the smart client visualization application is adapted to request retrieval of the latest system-oriented data from the application database.

8. The system of claim 1 adapted to package the most recent system-oriented data into a lightweight data-interchange format.

9. The system of claim 1 wherein the application database is adapted to transmit the most recent system-oriented data package to the client visualization system via the web service.

10. The system of claim 1 wherein the smart client visualization application is adapted to request retrieval of the event-oriented data from the event database.

11. The system of claim 1 adapted to package requested event-oriented data into a lightweight data-interchange format.

12. The system of claim 1 wherein the event database is adapted to transmit the package of requested event-oriented data to the client visualization system visualization system via the web service.

13. The system of claim 1 wherein the smart client visualization application is capable of performing post event analysis.

14. The system of claim 13 wherein the smart client visualization application is capable of performing the event replay offline and disconnected from the web service.

15. A method of real-time, wide-area power system monitoring and visualization comprising:
receiving synchronized, real-time data objects in a first-in, first-out synchronized data object queue contained in an application memory resident database;
requesting retrieval of the latest system-oriented data from the application database by a smart client visualization application;
packaging the most recent system-oriented data into a lightweight data-interchange format:
transmitting the most recent system-oriented data package to the client visualization system via a web service: and
operating the smart client visualization application.

16. The method of claim 15 including transferring event-oriented data to an event database from the synchronized data object queue, using an event-triggered data archive service.

17. The method of claim 16 including:
requesting retrieval of the event-oriented data from the event database by the smart client visualization application:
packaging requested event-oriented data into a lightweight data-interchange format; and,
transmitting the package of requested event-oriented data to the client visualization system visualization system via the web service.

18. The method of claim 16 including selecting a particular event from an event list and selecting a specified time window within the smart client visualization application.

19. The method of claim 17 including performing event replay at the smart client visualization application utilizing local resources and the requested event-oriented data stored in the local smart client computer.
